(19) United States
(12) Patent Application Publication
(10) Pub. No.: US 2009/0058824 A1
(43) Pub. Date: Mar. 5, 2009

(54) PORTABLE COMMUNICATION DEVICE HAVING A NEAR-INFRARED TOUCH INPUT DISPLAY

(75) Inventors: Bengt Nissar, Stockholm (SE); Per-Ragnar Hansson, Stockholm (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/048,836

(22) Filed: Mar. 14, 2008

Related U.S. Application Data
(60) Provisional application No. 60/969,324, filed on Aug. 31, 2007.

(51) Int. Cl. G06F 3/041

(52) U.S. Cl. 345/173

(57) ABSTRACT

A portable communication device is equipped with a touch input display that includes a source of non-visible light integrated within touch input display and a plurality of photodetectors integrated within the touch input display, wherein the photodetectors are configured to detect non-visible light. The portable communication device is configured to detect touch of the display without additional touch-sensitive layers disposed over the display, as well as to detect touch in dark environments and/or with dark images or backgrounds on the display.

### RELATED APPLICATION DATA

The present application claims the benefit of U.S. Provisional Application Ser. No. 60/969,324, filed Aug. 31, 2007, the disclosure of which is herein incorporated by reference in its entirety.

### TECHNICAL FIELD OF THE INVENTION

The present invention relates generally to portable communication devices, and more particularly, to a portable communication device having a near infrared in-cell touch input display.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

The wireless industry is experiencing a rapid expansion of mobile data services and enhanced functionality. In addition, the features associated with certain types of portable communication devices have become increasingly diverse. To name a few examples, many portable communication devices have text messaging capability, Internet browsing functionality, electronic mail capability, video playback capability, audio playback capability, image display capability and hands-free headset interfaces.

In order to accommodate the information display requirements associated with today's mobile phones, most mobile phones include a liquid crystal display (LCD) on which information is displayed. In addition, many mobile phones now include touch input devices, such as touch screens or touch panels through which the user can provide user input. Many conventional touch screens are resistive or capacitive in nature, and include added components or layers, e.g., layers on top of the display, which may add cost and reduce optical performance of the display.

### SUMMARY

In view of the foregoing, a need exists for a portable communication device having an improved touch screen.

The present invention provides a portable communication device having a touch input display. The touch input display is configured to include a source of non-visible light integrated within the display and a plurality of photodetectors integrated within the display and configured to detect non-visible light. The touch input device eliminates the need for top touch-sensitive layers, and is capable of providing touch input operation in dark environments with improved signal-to-noise ratio.

One aspect of the invention relates to a portable communication device that includes a housing and a touch input display disposed within the housing. The touch input display includes a top substrate disposed to receive touch by a user, a source of non-visible light integrated within the touch input display, and a plurality of photodetectors integrated within the touch input display, where the photodetectors are configured to detect non-visible light.

According to another aspect, the source of non-visible light is configured to emit light within a predetermined wavelength range, and the photodetectors are configured to detect non-visible light within the predetermined wavelength range.

According to another aspect, the predetermined wavelength range includes about 700 nanometers to about 1000 nanometers.

According to another aspect, the source of non-visible light is configured to emit infrared or near-infrared light.

According to another aspect, the photodetectors are configured to detect infrared or near-infrared light.

According to another aspect, the touch input display is configured such that non-visible light emitted by the source of non-visible light passes through the touch input display to the top substrate of the touch input display.

According to another aspect, touch input display includes a plurality of material layers between the source of non-visible light and the top substrate, and wherein at least some of the material layers are configured to permit transmission of non-visible light from the source of non-visible light.

According to another aspect, the touch input display has a display area, and the source of non-visible light includes a plurality of light emitting diodes disposed adjacent edges of the display area to direct non-visible light toward the top substrate.

According to another aspect, the photodetectors are configured to detect non-visible light reflected by an object in contact with the top substrate.

According to another aspect, the portable communication device includes control circuitry configured to determine a position on the touch input display contacted by a user based on the reflected non-visible light detected by the photodetectors.

According to another aspect, the source of non-visible light is configured to modulate emission of the non-visible light at a predetermined frequency.

According to another aspect, the photodetectors are configured to detect non-visible light modulated at the predetermined frequency.

According to another aspect, the source of non-visible light is configured to pulse emission of non-visible light at a predetermined pulse rate, and the photodetectors are configured to detect non-visible light according to the predetermined pulse rate.

According to another aspect, the source of non-visible light includes one or more light emitting diodes.

According to another aspect, the photodetectors comprise photo-sensitive thin film transistors (TFTs) tuned to detect non-visible light having a wavelength that substantially matches the wavelength of the light emitting diodes.

According to another aspect, the touch input display is a liquid crystal display.

According to another aspect, the portable communication device is a mobile telephone.

Another aspect of the invention relates to a touch input display device that includes a top substrate disposed to receive touch by a user, a source of non-visible light integrated within the display device, and a photodetector integrated within the display device, the photodetector being configured to detect non-visible light.

According to another aspect, the touch input display is configured such that non-visible light emitted by the source of non-visible light passes through the touch input display to the top substrate of the touch input display.

According to another aspect, the photodetector is configured to detect non-visible light reflected by an object in contact with the top substrate.

According to another aspect, the source of non-visible light is configured to emit infrared or near-infrared light within a predetermined wavelength range, and wherein the photodetector is configured to detect infrared or near-infrared light within the predetermined wavelength range.

According to another aspect, the source of non-visible light is configured to modulate emission of the non-visible light at a predetermined frequency, and the photodetector is configured to detect non-visible light modulated at the predetermined frequency.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a mobile phone as an exemplary portable communication device having a touch input display in accordance with the present invention;

FIG. 2 is a diagrammatic illustration of a portable communication device having a touch input device;

FIG. 3 is a diagrammatic illustration of a top view of an exemplary touch input device;

FIG. 4 is a sectional view of an exemplary touch input display in accordance with one embodiment;

FIG. 5 is a sectional view of an exemplary touch input display in accordance with another embodiment;

FIG. 6 is a sectional view of an exemplary touch input display in accordance with another embodiment; and

FIG. 7 is a sectional view of an exemplary touch input display in accordance with another embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Touch input displays have aesthetic and functional benefits. Some touch input displays include additional resistive or capacitive touch-sensitive layers on top of the display. These extra layers may reduce optical performance. A touch input displays may be configured to detect visible light that passes through the display, as well as shadows cast by objects in contact with the display. While improving on displays having additional touch-sensitive layers, the detection of visible light and associated shadows may provide less than optimal performance in dark environments and/or in connection with darker images on the display.

The present disclosure describes a portable communication device equipped with a touch input display that is configured to receive user input via user touch of the display surface, e.g., touch by finger or touch by stylus. The touch input display is configured to include a source of non-visible light and one or more photodetectors configured to detect non-visible light, e.g., infrared or near-infrared light. The source of non-visible light may be configured to pass the non-visible light through the display to a top substrate of the display. Non-visible light reflected by an object in contact with a portion of the display may be detected by the photodetectors to determine a position of the touch on the display. This configuration allows for touch input functionality without employing additional layers on top of the display, as well as operation in darker environments and improved signal-to-noise ratio.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment equipped with a touch input display.

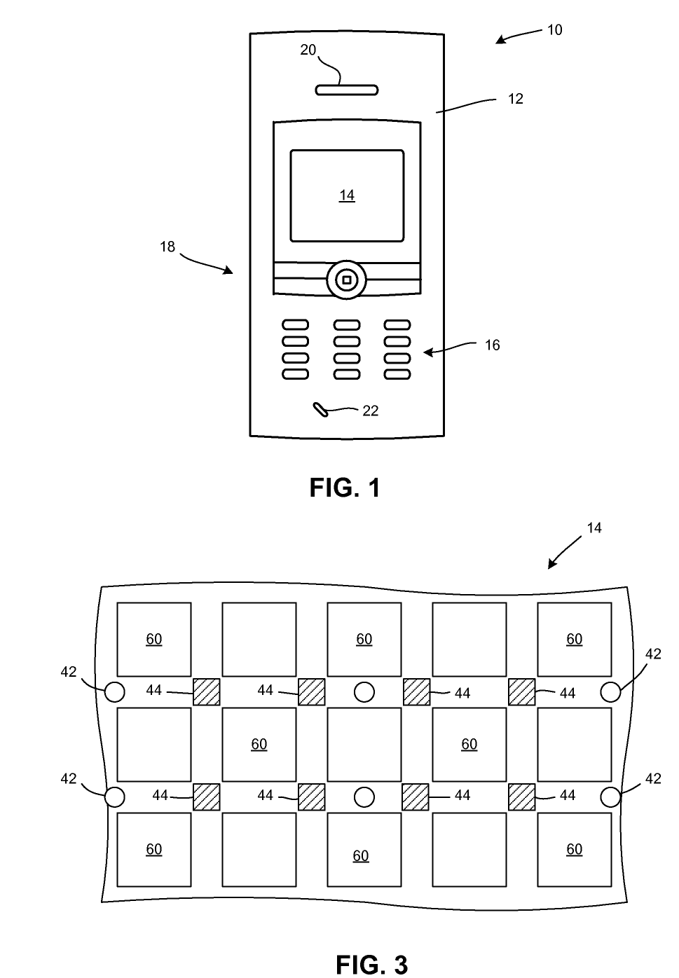

Referring initially to FIG. 1, a portable communication device 10 is shown in accordance with the present invention. In the exemplary embodiment described herein, the portable communication device is a mobile phone 10. Of course, it will be appreciated that the present invention is applicable to other portable communication devices. The mobile phone 10 is shown as having a “block” type of housing 12, but it will be appreciated that other housing types, such as clamshell or slide-type housings may be utilized without departing from the scope of the present invention.

The mobile phone 10 includes a touch input display 14, an alphanumeric keypad 16, one or more functional keys 18, e.g., a joystick or rocker key, a speaker 20 and a microphone 22. The alphanumeric keypad 16 and the functional keys 18, facilitate controlling operation of the mobile phone 10 by allowing for entry of alphanumeric information, such as telephone numbers, phone lists, contact information, notes and the like. The functional keys 18 typically facilitate navigation through various user menus including initiating and conducting phone calls and other communications.

The touch input display 14 displays information to a user, such as recorded digital media, e.g., recorded photos and videos, operating state, time, phone numbers, contact information and various navigational menus, which enable the user to utilize the various features of the mobile phone 10. In addition, the touch input display 14 is configured to receive user input via detection of user touch of the display, e.g., a touch by finger or by stylus. As is discussed more fully below, the touch input display is configured to include an integrated source of non-visible light and photodetectors configured to detect non-visible light. Artisans will appreciate that the mobile phone 10 further includes suitable circuitry and software for performing various functionality. The circuitry and software of the mobile phone is coupled with input devices, such as the alphanumeric keypad 16, the functional keys 18 and the microphone 22, as well as to the input/output devices, including the touch input display 14 and the speaker 20. It will be appreciated that the touch input display may have any suitable size, shape and positioning without departing from the scope of the present invention. Also, while the exemplary mobile phone 10 is described as having a keypad 16, functional keys and a touch input display 14, it will be appreciated that the mobile phone may include only the touch input display 14 as the primary means for receiving alphanumeric user input and/or navigation commands.

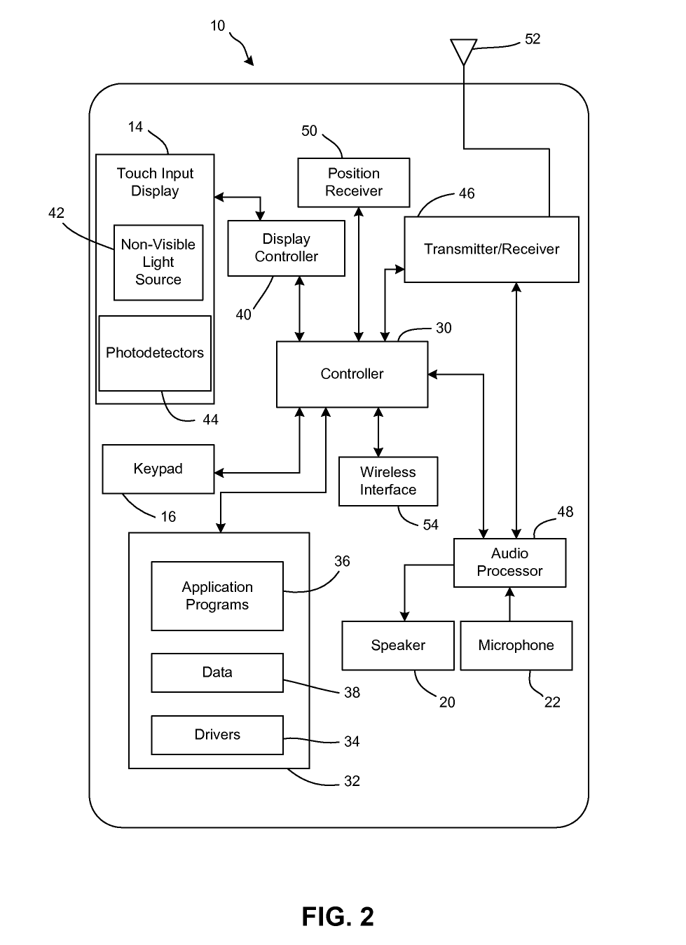

FIG. 2 represents a functional block diagram of a portable communication device 10, e.g., a mobile phone. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, and application program data 38. The I/O device drivers include software routines that are accessed through the controller 30 (or by an operating system (not shown) stored in memory 32) by the application programs 36 to communicate with devices such as the touch input display 14, the keypad 16 (e.g., a standard keypad, a QWERTY keypad or a touch screen keypad), as well as other input/output ports. As is described more fully below, the touch input display is operatively coupled to and controlled by a display controller 40 (e.g., a suitable microcontroller or microprocessor) and configured to facilitate touch input functionally (detection of user touch of the display and recognition of desired user input based on the touch of the display). As is described more fully below, the touch input display includes one or more sources of non-visible light 42 and one or more photodetectors 44 configured to detect non-visible light. The display controller 40 cooperates with the touch input display 14 to detect user touch or manipulation of the touch input display and to send “events” (e.g., a keypress event) to the controller based on detected user manipulation of the touch input display 14.

The application programs 36 comprise programs that implement various features of the portable communication device 10, such as voice calls, e-mail, Internet access, multimedia messaging, contact manager and the like.

With continued reference to FIG. 2, the controller 30 interfaces with the aforementioned touch input display 14, keypad 16 (and any other user interface device(s)), a transmitter/receiver 46 (often referred to as a transceiver), audio processing circuitry, such as an audio processor 48, and a position determination element or position receiver 50, such as a global positioning system (GPS) receiver. The portable communication device 10 may include a media recorder (e.g., a still camera, a video camera, an audio recorder or the like) that captures digital pictures, audio and/or video. Image, audio and/or video files corresponding to the pictures, songs and/or video may be stored in memory 32.

An antenna 52 is coupled to the transmitter/receiver 46 such that the transmitter/receiver 46 transmits and receives signals via antenna 52, as is conventional. The portable communication device includes an audio processor 48 for processing the audio signals transmitted by and received from the transmitter/receiver. Coupled to the audio processor 44 are a speaker 20 and microphone 22, which enable a user to listen and speak via the portable communication device. Audio data may be passed to the audio processor 48 for playback to the user. The audio data may include, for example, audio data from an audio file stored in the memory 32 and retrieved by the controller 30 or audio data associated with a generated or received media-enhanced text message. The audio processor 48 may include any appropriate buffers, decoders, amplifiers and the like.

The portable communication device also may include one or more local wireless interfaces (indicated generally as wireless interface 54), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 54 may be representative of an interface suitable for communication within a cellular network or other wireless wide-area network (WWAN).

Referring now to FIG. 3, a top view of a portion of an exemplary touch input display 14 is depicted. In a preferred embodiment, the touch input display is a liquid crystal display (LCD), e.g., a backlit LCD, however, other display types may be employed without departing from the scope of the present invention. The touch input display 14 includes a plurality of pixels 60. As is described more fully below, it will be appreciated that in the case of a color LCD display, for example, each pixel 60 may be made up of one or more pixel electrodes coupled with appropriate color filters, e.g., red, green and blue color filters, to provide a suitable color display.

The touch input display is configured such that one or more sources of non-visible light 42 are integrated within the display. In one embodiment, the source of non-visible light includes one or more sources of infrared light or near-infrared light, e.g., light having a wavelength in the range of about 700 nanometers to about 1,000 nanometers. In one embodiment, the source of non-visible light includes one or more light emitting diodes disposed within the touch input display such that non-visible light from the light emitting diodes passes through the display towards a top substrate, e.g., a top glass or plastic cover plate. As is described more fully below, the sources of non-visible light may be disposed in various locations within the touch input display, such as near or integrated with the backlight of the display.

As shown in FIG. 3, the touch input display 14 also is configured with one or more photodetectors 44 that are configured or otherwise tuned to detect non-visible light, e.g., light having a wavelength that matches or substantially matches the wavelength of the non-visible light emitted by the non-visible light source(s) 42. In one embodiment, the photodetectors 44 may include photo-sensitive thin film transistors (photo TFTs) that are configured to detect infrared or near-infrared light having a wavelength that matches or substantially matches the wavelength of the infrared or near-infrared light emitting diodes. Alternatively, other types of photodetectors may be employed without departing from the scope of the present invention. Also, it will be appreciated that various configurations of the photodetectors 44 may be provided without departing from the scope of the present invention.

For example, the touch input display may be configured such that the display includes one photodetector for every four pixels (where one pixel may be made up of a number of pixel electrodes and color filters), one photodetector for every eight pixels, one photodetector for every sixteen pixels or the like. The number and configuration of the photo detectors tuned to detect the non-visible light may be adjusted based on a number of factors, including, but not limited to, the size and shape of the display, the overall resolution of the display, the sensitivity of the individual photodetectors and the like.

As will be discussed more fully below, the provision of a touch input display having sources of non-visible light and suitable corresponding photodetectors configured or otherwise tuned to detect non-visible light, may provide for a display having touch input functionality without the requirement of additional layers, e.g., resistive or capacitive layers, disposed over the top substrate of the display. Further, the use of non-visible light to detect a user touch of the display also allows for modulation of the light sources and corresponding tuning of the photo detectors without disrupting the user's viewing and/or use of the display. As is described more fully below, the non-visible light sources 42 and photodetectors 44 are configured such that non-visible light passes through the display toward the top substrate of the display, and non-visible light reflected from an object, e.g., a user's finger or stylus, in contact with top substrate is received by the photodetectors to determine a user's desired input provided via contact with the touch input display.

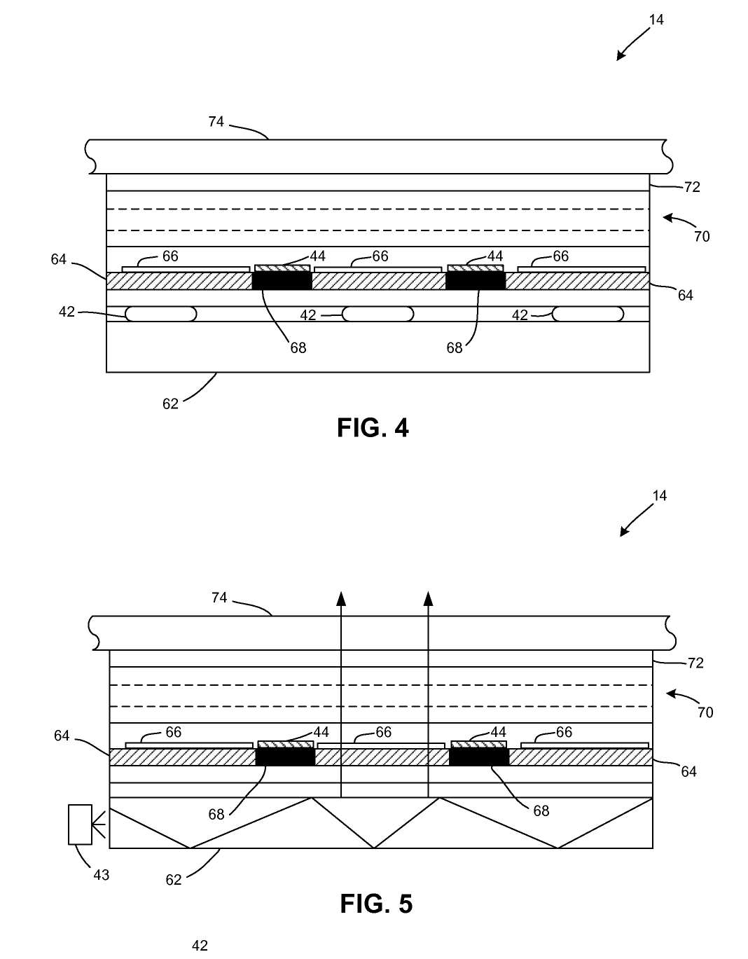

Turning now to FIGS. 4-7, sectional views are presented for various embodiments of the touch input display 14. It will be appreciated that like elements will be referred to with like reference numerals in the various embodiments depicted in FIGS. 4-6. Turning now to FIG. 4, a sectional view of an exemplary touch input display 14 in accordance with one embodiment is provided. In this exemplary embodiment, the touch input display 14 is a LCD-type display, e.g., an active matrix LCD (AMLCD). The display 14 includes a backlight 62, e.g., an array of light emitting diodes (LEDs), fluorescent tubes, xenon flat lamps or the like, that provides light for transmission through and out of the display for use in the formation of images on the display. A plurality of non-visible light sources 42 are disposed or otherwise integrated within the display. In a preferred embodiment, the non-visible light sources 42 include a plurality of light emitting diodes that are configured to emit light having a wavelength within the non-visible region. In one embodiment, the sources 42 are configured to emit infrared or near-infrared light (for example, light having a wavelength of about 700 nanometers to about 1,000 nanometers). Of course, the sources may be configured to emit non-visible light having wavelengths other than those disclosed above without departing from the scope of the present invention.

In the embodiment shown in FIG. 4, the non-visible light sources 42 are near or otherwise integrated with the backlight 62. In this embodiment, the layers disposed over or above the sources of non-visible light 42 are configured to transmit light having a wavelength corresponding to the wavelength of the light emitted by the non-visible light sources. In the illustrated embodiment, the display includes a plurality of color filters 64, e.g., red, green and blue color filters, which serve to provide a display having full color functionality.

A plurality of pixel electrodes 66 is disposed within the display. In the illustrated embodiment, the pixel electrodes 66 are disposed over the respective color filters, however, it will be appreciated that the pixel electrodes may also be disposed in other locations, e.g., below the respective color filters, without departing from the scope of the present invention. In the illustrated embodiment, the color filters are separated by black matrix portions 68, which typically are employed to protect light-sensitive semiconductor components that may be disposed below the black matrix portions 68. Such components may include thin filmed transistors (TFT) that are configured to selectively energize or otherwise address the various pixel electrodes. In the embodiment illustrated in FIG. 4, the pixel electrodes may be comprised of an electrically conductive, yet transparent material such that light from the non-visible light sources 42 passes through the pixel electrodes.

The display further includes a layer of liquid crystal material 70, which typically is disposed between a pair of orientation films (not shown). Orientation films may include glass substrates or other material substrates having surfaces that are buffed to produce microscopic grooves to physically align the molecules of the liquid crystal material immediately adjacent the substrate walls. For example, in the case of a twisted nematic liquid crystal display, molecular forces may cause adjacent crystal molecules to attempt to align with neighbors having a result that the orientation of molecules in a given column of molecules spanning the liquid crystal cell gap twists over the length of the column. Typically, the liquid crystal display will include a pair of polarizers (not shown) that cooperate with the liquid display to selectively produce light areas and dark areas depending upon the configuration of the liquid crystal cell and the respective voltages applied to the pixel electrodes 66 and the top (typically continuous) electrode 72. The general workings of liquid crystal displays are well-understood by those skilled in the art, therefore a detailed discussion of the general operation of liquid crystal cell will not be provided. The touch input display 14 further includes a top substrate 74 that is exposed or otherwise configured to receive touch input from a user of the device in which the touch input display is disposed. Touch may include a touch by the user's finger and/or touch by the user using a stylus or other appropriate manipulation tool.

In the embodiment shown in FIG. 4, the touch input display is configured such that layers and components disposed above the non-visible light sources 42 are transmissive to light from the sources 42. Accordingly, non-visible light may be transmitted through the various layers of the display to the top substrate 74 (for ultimate reflection by an object contacting the top substrate) without adversely affecting the user's enjoyment of the display. Non-visible light reflected off an object, e.g., a user's finger or a stylus, contacting the top substrate 74 may pass back through various layers of the display for detection by the photo detectors 44. As is discussed above, the photo detectors may include any suitable photo-sensitive element configured to detect non-visible light having a wavelength that matches or substantially matches the wavelength of the non-visible light emitted by the sources 42, e.g., photo sensitive thin film transistors (TFT).

In this configuration, the display is capable of the position of contact by a user touching the touch input display (either with the user's finger or with a stylus). In a preferred embodiment, the display operates in a “reflective mode” in which light emitted by the sources of non-visible light 42 emit light that may generally pass through the top substrate except for when a user touches the display (using a finger or stylus), at which time the non-visible light is reflected off of the object touching the display for ultimate detection by the photodetectors 44. The photodetectors may cooperate with a suitable controller to determine the location on the screen at which point the user makes contact with the screen. It will be appreciated that the operation of the display may not be confined to “reflective mode” operation. For example, the display may also operate in a transmissive mode without departing from the scope of the present invention.

In a preferred embodiment, control circuitry cooperates with non-visible light sources 42 to modulate or otherwise controllably emit light form the non-visible light sources. For example, the non-visible light sources 42 may be configured to blink the non-visible light at a predetermined frequency, e.g., one kilohertz or the like. Alternatively, the non-visible light sources may be configured to provide a short pulse of non-visible light followed by a period of no emission of non-visible light, e.g., a one millisecond pulse of light followed by a twenty millisecond period of the light being off. Modulation and/or pulsing of the non-visible light sources may provide advantages, including, but not limited to saving power and a better signal-to-noise ratio in the detection of the infrared or near-infrared light by the photo detectors. For example, the photo detectors may be configured with appropriate lock-in amplifiers to lock into the modulated frequency of the non-visible light, thereby removing noise and improving signal-to-noise ratio. Of course, all of this modulation and/or pulsing of the non-visible light may be carried out without detection by the user because of the use of the non-visible light.

While FIG. 4 discusses the backlight 62 in terms of a plurality or array of LEDs and non-visible light sources 42 disposed along a “long side” of the display, it will be appreciated that other configurations may be employed without departing from the scope of the present invention. For example, FIG. 5 illustrates another exemplary embodiment in which light is transmitted from the “short side” of the backlight. As shown in FIG. 5, a light source 43, which may be configured to emit visible light and non-visible light of a predetermined wavelength or predetermined wavelengths, may be disposed adjacent a side portion of the backlight 62. Light from light source 43 may illuminate the backlight (and, therefore, the display), as is shown in FIG. 5.

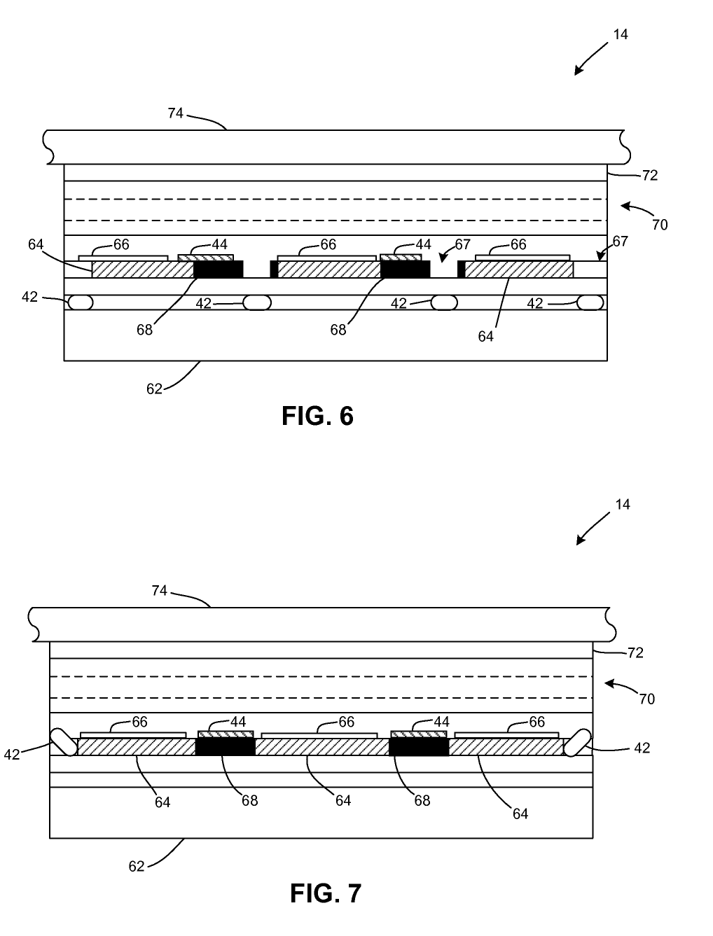

Turning now to FIG. 6, an alternative embodiment of the touch input display 14 is provided. As is discussed above with reference to FIG. 4, the display 14 includes a suitable backlight 62, non-visible light sources 42 disposed on or near the backlight, a plurality of color filters 64 separated by black matrix portion 68, and photodetectors 44 tuned to detect non-visible light are provided. A layer of liquid crystal material 70 is disposed generally between pixel electrodes 66 and a top (typically continuous) top electrode 72. As is noted above, as with typical liquid displays, the display may include suitable orientation films, planarization layers, polarizers and the like. A top substrate 74 is disposed at the top of the display and positioned to receive input via touch from a user.

The embodiment shown in FIG. 6 differs from the embodiment shown in FIG. 4 in that one or more of the layers disposed above the non-visible light sources 42 are segmented or otherwise altered include openings 67 that allow passage of the non-visible light through what might otherwise be layers that are opaque to non-visible light. It will be appreciated that the invention described herein is not limited to any particular configuration of openings within the various active matrix layers, but is applicable to any suitable configuration of openings developed by one of ordinary skill in the art. As is discussed above with reference to FIG. 4, the display is configured to allow the non-visible light to pass through the various layers of the display and generally out of or through the top substrate 74. In a reflective mode, non-visible light may be reflected by an object in contact with a portion (or portions) of the top substrate 74. The reflected light may then be detected by the various photo detectors 44 and used to determine the location of user touch, and therefore, desired user input.

Turning now to FIG. 7, an alternative embodiment of the touch input display 14 is provided. Similar to that described with respect to FIG. 4 and FIG. 6, the embodiment shown in FIG. 7 includes a backlight 62, a plurality of color filters 64 separated by black matrix portions 68, a plurality of pixel electrodes 66 and a top electrode 72 surrounding a layer of liquid crystal material 70. As is discussed above, the display 14 is configured to include one or more non-visible light sources 42, e.g., a plurality of light emitting diodes that are configured to emit non-visible light, as well as a plurality of photo detectors 44 that are configured to detect non-visible light having a wavelength or wavelengths that match or substantially match the wavelength or wavelengths emitted by the non-visible light sources. In this embodiment, the non-visible light sources 42 are positioned or otherwise disposed on sides or edges of the display or the edges of the display area of the display (typically angled upward toward the top substrate 74). In this configuration, various active matrix layers of the display may be opaque to the non-visible light, yet the display may be configured to pass non-visible light toward the top substrate for ultimate reflection by an object in contact with the top surface and detection of the reflected light by the photodetectors.

Similar to that discussed above, in this embodiment, the display also may be operated in a reflective mode in which non-visible light reflects off of a user's finger or stylus making contact with a portion of the top substrate of the display, whereby the reflected light is detected by one or more of the photo detectors to determine the position of the user's touch relative to the display, and thereby determine the user's desired action. Alternatively, the display may be operated in a transmissive mode.

It should be appreciated that each of the embodiments described in FIGS. 4-6 allow for modulation or otherwise controlled emission of the non-visible light coupled with frequency locking on the part of the photodetectors. Such modulation or controlled emission of the non-visible light will have no effect on the user's enjoyment of the display because only non-visible light is being modulated or pulsed.

The provision of a touch input display configured with non-visible light sources and corresponding photo detectors configured to detect non-visible light may provide one or more advantages in the operation of the mobile phone (or other electronic equipment). For example, typically no extra touch panel (e.g., a resistive or capacitive touch panel or layer) would be required on top of the top substrate, which would improve optical performance, overall size and cost of the display. Further, it may be possible with the display described above to receive and process a double input, e.g., input where a user contacts two portions of the display at the same time. Also, the touch input display described above typically should not be affected by surrounding light conditions or the brightness of the user interface or image shown on the display. These benefits, in turn, may lead to better smart phones, more attractive displays and dual inputs for gaming and other applications in which dual inputs may be desirable.

The use of non-visible light also provides for improved performance when the mobile phone is in a dark environment (because there should be no need to rely on ambient light for touch detection). Also, the provision of modulating the non-visible light sources and tuning or otherwise locking the photodetectors to the modulated light will provide an increase in signal-to-noise ratio.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a touch input display disposed within the housing, wherein the touch input display comprises:
a top substrate disposed to receive touch by a user;
a source of non-visible light integrated within the touch input display; and
a plurality of photodetectors integrated within the touch input display, the photodetectors being configured to detect non-visible light.

2. The portable communication device according to claim 1,
wherein the source of non-visible light is configured to emit light within a predetermined wavelength range, and the photodetectors are configured to detect non-visible light within the predetermined wavelength range.

3. The portable communication device according to claim 2, wherein the predetermined wavelength range includes about 700 nanometers to about 1000 nanometers.

4. The portable communication device according to claim 1, wherein the source of non-visible light is configured to emit infrared or near-infrared light.

5. The portable communication device according to claim 4, wherein the photodetectors are configured to detect infrared or near-infrared light.

6. The portable communication device according to claim 1, wherein the touch input display is configured such that non-visible light emitted by the source of non-visible light passes through the touch input display to the top substrate of the touch input display.

7. The portable communication device according to claim 6, wherein touch input display includes a plurality of material layers between the source of non-visible light and the top substrate, and wherein at least some of the material layers are configured to permit transmission of non-visible light from the source of non-visible light.

8. The portable communication device according to claim 6, wherein the touch input display has a display area, and the source of non-visible light includes a plurality of light emitting diodes disposed adjacent edges of the display area to direct non-visible light toward the top substrate.

9. The portable communication device according to claim 6, wherein the photodetectors are configured to detect non-visible light reflected by an object in contact with the top substrate.

10. The portable communication device according to claim 9, further comprising control circuitry configured to determine a position on the touch input display contacted by a user based on the reflected non-visible light detected by the photodetectors.

11. The portable communication device according to claim 1, wherein the source of non-visible light is configured to modulate emission of the non-visible light at a predetermined frequency.

12. The portable communication device according to claim 11, wherein the photodetectors are configured to detect non-visible light modulated at the predetermined frequency.

13. The portable communication device according to claim 1, wherein the source of non-visible light is configured to pulse emission of non-visible light at a predetermined pulse rate, and the photodetectors are configured to detect non-visible light according to the predetermined pulse rate.

14. The portable communication device according to claim 1, wherein the source of non-visible light includes one or more light emitting diodes.

15. The portable communication device according to claim 14, wherein the photodetectors comprise photo-sensitive thin film transistors (TFTs) tuned to detect non-visible light having a wavelength that substantially matches the wavelength of the light emitting diodes.

16. The portable communication device according to claim 1, wherein the touch input display is a liquid crystal display.

17. The portable communication device according to claim 1, wherein the portable communication device is a mobile telephone.

18. A touch input display device comprising:
a top substrate disposed to receive touch by a user;
a source of non-visible light integrated within the display device; and
a photodetector integrated within the display device, the photodetector being configured to detect non-visible light.

19. The touch input display according to claim 18, wherein the touch input display is configured such that non-visible light emitted by the source of non-visible light passes through the touch input display to the top substrate of the touch input display.

20. The touch input display according to claim 19, wherein the photodetector is configured to detect non-visible light reflected by an object in contact with the top substrate.

21. The touch input display according to claim 20, wherein the source of non-visible light is configured to emit infrared or near-infrared light within a predetermined wavelength range, and wherein the photodetector is configured to detect infrared or near-infrared light within the predetermined wavelength range.

22. The touch input display according to claim 20, wherein the source of non-visible light is configured to modulate emission of the non-visible light at a predetermined frequency, and the photodetector is configured to detect non-visible light modulated at the predetermined frequency.
